(19) United States
(12) Patent Application Publication
(10) Pub. No.: US 2009/0279401 A1
(43) Pub. Date: Nov. 12, 2009

(54) Recording Medium, Apparatus and Method for Recording/Reproducing Data on/From Recording Medium

(76) Inventors: Sung Hoon Kim, Seoul (KR); Yong Cheol Park, Seoul (KR)

Correspondence Address: HARNESS, DICKEY & PIERCE, P.L.C., P.O. BOX 8910, RESTON, VA, 20195, US

(21) Appl. No.: 12/308,885

(22) PCT Filed: Mar. 13, 2007
(86) PCT No.: PCT/KR2007/001224

§ 371 Date: Dec. 29, 2008

(30) Foreign Application Priority Data
Jul. 6, 2006 (KR) 10-2006-0063561

(51) Int. Cl. G11B 20/00

(52) U.S. Cl. 369/47.15; G9B/20

(57) ABSTRACT

A recording medium and an apparatus for recording/reproducing data on the recording medium, which are capable of controlling access to the recording medium by recording control information for controlling access for reading the data, are disclosed. When a function included in the recording medium cannot be performed, Unknown Rules are applied, and, when the function included in the recording medium can be performed, Known Rules are applied. Even in the Known Rules, a password may be used such that data reading is controlled. Accordingly, it is possible to compatibly reproduce the data from different versions of recording media. It is difficult for a user to access to the recording medium such that content protection can be improved.

### TECHNICAL FIELD

The present invention relates to a recording medium and an apparatus and method for recording/reproducing data on/from the recording medium, and more particularly, to an apparatus and method for recording/reproducing data on/from a recording medium while controlling access to the recording medium.

### BACKGROUND ART

In general, an optical recording/reproducing apparatus records/reproduces data on/from a disc such as a compact disc (CD), a digital versatile disc (DVD) or a Blu-ray disc (BD). As the preferences of consumers have changed, a technology for processing a high-definition moving image is required. In addition, as a moving-image compression technology has been developed, a high-density recording medium is required. Recently, new high-density recording media are under development, which enable long duration recording and storing of high definition video and audio data.

In order to standardize new recording media, new versions of standards generally continue to be established. When the standards are established, recording/reproducing apparatuses (also referred to as “players” or “recorders”) suitable for the standards are generally developed, which will be described in detail with respect to FIG. 1. A recording/reproducing apparatus 10a corresponds to an old version of optical disc 10a and a recording/reproducing apparatus 10b corresponds to a new version of optical disc 100b.

The recording/reproducing apparatus 10b is designed such that data can be recorded/reproduced on/from the old version of optical disc 100a as well as the new version of optical disc 100b. Meanwhile, the recording/reproducing apparatus 10a can record/reproduce data on/from only the old version of optical disc 10a and cannot efficiently correspond to the new version of optical disc 100b. This is because the standard on the new version of optical disc 100b was not established when designing the recording/reproducing apparatus 10a.

Accordingly, in a step of standardizing the new version of optical disc 100b, it is preferable that compatibility is maintained such that data on the new version of optical disc 100b can be reproduced by the old version of recording/reproducing apparatus 10a. At this time, a case where the data on the new version of optical disc 100b can be recorded/reproduced by the old version of recording/reproducing apparatus 10 as denoted by a dotted line of FIG. 1 is referred to as “backward compatibility”. The incompatible recording/reproducing apparatus 10a may damage a recording medium or data stored in the recording medium. Therefore, the incompatible recording/reproducing apparatus 10a needs to be restricted from accessing to the recording medium.

Even in the compatible recording/reproducing apparatus 10b, when an unauthorized person accesses to the data recorded on the recording medium, the data may be damaged and intellectual property rights may be infringed due to unauthorized duplication. Therefore, the unauthorized person needs to be restricted from accessing to the recording medium.

### DISCLOSURE OF INVENTION

Accordingly, the present invention is directed to a recording medium and an apparatus and method for recording/reproducing data on/from the recording medium that substantially obviate one or more problems due to limitations and disadvantages of the related art.

An object of the present invention is to provide a recording medium having improved data protection.

Another object of the present invention is to provide a recording medium having recorded thereon information for controlling access to the recording medium.

Another object of the present invention is to provide a method and apparatus suitable for the recording medium.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, a recording medium includes: a data area in which data is recorded; and a management area in which management information of the data is recorded, wherein an area in which reading control information for controlling reading of the data is recorded is assigned to the management area. The reading control information may be information for controlling the reading of all or a specific part of the data recorded on the recording medium. The management area may include a field having recorded therein address information of an area in which the data reading is controlled. The area in which the data reading is controlled may be an area specified by a user in the data area recorded on the recording medium when recording the reading control information. The reading control information may include a first rule applied when the recording medium is recognized and a second rule applied when the recording medium is not recognized.

In another aspect of the present invention, there is provided a method for reproducing data recorded on a recording medium, including: obtaining reading control information recorded in a management area of the recording medium; and controlling access for reading the data with respect to the data recorded on the recording medium or a predetermined area in which the data is recorded, according to the reading control information

In another aspect of the present invention, there is provided a method for recording data on a recording medium, including: recording the data in a data area of the recording medium; and recording management information of the data in a management area of the recording medium, wherein the management information includes reading control information for controlling reading of the recorded data.

In another aspect of the present invention, there is provided an apparatus for recording/reproducing data on/from a recording medium, including: a pickup unit; and a controller which controls access for reading the data with respect to the data recorded on the recording medium or a predetermined area in which the data is recorded, according to reading control information recorded in a management area of the recording medium. The controller may apply different rules for controlling the access for reading the data, depending on whether the recording medium is recognized or not. The rules may include a first rule which is applied when the recording medium is recognized and a second rule which is applied when the recording medium is not recognized.

It is to be understood that both the foregoing general description and the following detailed description of the present invention are exemplary and explanatory and are intended to provide further explanation of the invention as claimed.

### BRIEF DESCRIPTION OF DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a conceptual diagram of the present invention;

FIG. 2 is a view showing an example of the structure of a recording medium according to the present invention;

FIG. 3 is a view showing DRP_PAC information according to an embodiment of the present invention;

FIG. 4 is a view showing an example of Unknown PAC Rules included in the DRP_PAC information;

FIG. 5 is a view showing an example of Known PAC Rules included in the DRP_PAC information;

FIGS. 6A and 6B are views showing examples of RP_flag according to an embodiment of the present invention;

FIG. 7 is a block diagram showing the configuration of a recording/reproducing apparatus according to an embodiment of the present invention;

FIG. 8 is a flowchart illustrating a method for recording DRP_PAC information according to an embodiment of the present invention;

FIG. 9 is a flowchart illustrating a method for reproducing data according to the DRP_PAC information; and

FIG. 10 is a flowchart illustrating a method for reproducing data according to the Known PAC Rules.

### BEST MODE FOR CARRYING OUT THE INVENTION

Reference will now be made in detail to the preferred embodiments of the present invention, examples of which are illustrated in the accompanying drawings. Wherever possible, the same reference numbers will be used throughout the drawings to refer to the same or like parts.

In addition, although the terms used in the present invention are selected from generally known and used terms, some of the terms mentioned in the description of the present invention have been selected by the applicant at his or her discretion, the detailed meanings of which are described in relevant parts of the description herein. Furthermore, it is required that the present invention is understood, not simply by the actual terms used but by the meanings of each term lying within.

Hereinafter, the term “recording/reproducing apparatus” used in the present specification indicates all apparatuses for recording/reproducing data on/from a recording medium. The term “recording medium” used in the present specification indicates all media on which data is recorded or will be recorded, such as an optical disc or a magnetic tape, regardless of a recording method.

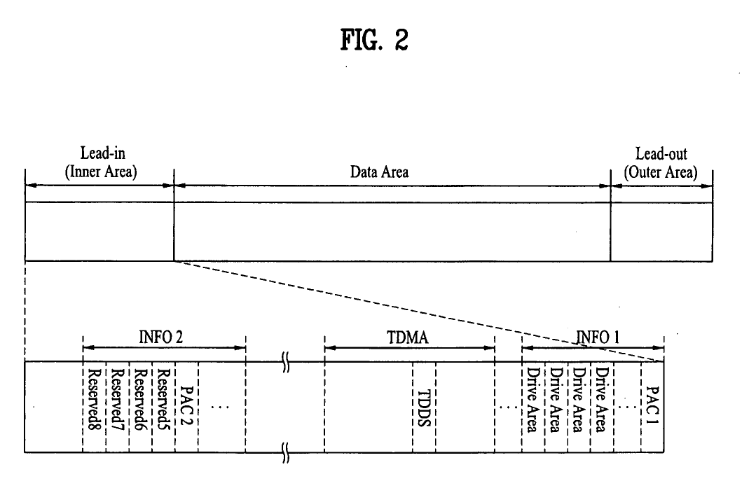

FIG. 2 is a view showing an example of the structure of a recording medium according to the present invention. In the present specification, for convenience of description, for example, a write-once recording medium will be described, but the recording medium according to the present invention is not limited to the embodiment and is applicable to a read-only recording medium or an overwritable recording medium. A recording medium having a single recording layer will be described, but the present invention is also applicable to a recording medium having a plurality of recording layers.

A recording medium according to an embodiment of the present invention includes a lead-in area, a data area, and a lead-out area from an inner circumference of the recording medium. The data area includes a user data area for recording user data and the other spare area (not shown). Each of the lead-in area and the lead-out area includes an area for recording control information and management information. The control information may include information for controlling access to the recording medium. In particular, as shown in FIG. 2, a physical access control area (hereinafter, referred to as a “PAC area”) for recording physical access control information (hereinafter, referred to as “PAC information”) for controlling physical access may be included.

The PAC area may be provided in the lead-in area, which will be described in detail with reference to FIG. 2. An information area included in the lead-in area includes an INFO1 area and an INFO2 area. The INFO1 area and the INFO2 area may include a PAC1 area and a PAC2 area, respectively. At this time, the INFO1 area may include drive areas for recording information on a drive, in addition to the PAC1 area. The drive areas may not be assigned if necessary. The PAC2 area included in the INFO2 area may be composed of backup copies of information recorded on the PAC1 area, which are provided for solving defects caused in the PAC information. The PAC area may be composed of 32 clusters and one piece of PAC information may be stored in the cluster unit. The cluster indicates a recording unit according to the present embodiment. Therefore, one recording medium may include plural pieces of PAC information in the PAC area. The detailed contents of the PAC information will be described in detail later with reference to the other drawings.

The lead-in area (or the lead-out area) includes a temporary disc management area (hereinafter, referred to as “TDMA”). The TDMA indicates an area for recording information for managing a defect caused when using the recording medium and general management information indicating a recording status in the recording medium, that is, an area having management information recorded therein. Therefore, information on validity of the PAC information or the control information may be recorded in the TDMA.

For example, status information of the PAC information may be recorded in a temporary disc definition structure (referred to as “TDDS”) including the general management information related to the structure of the recording medium included in the TDMA. In particular, when the status of the PAC information is represented by 2 bits, “00” indicates the PAC area in which the PAC information is not recorded, “10” indicates that invalid PAC information is recorded, and “11” indicates that valid PAC information is recorded. It is apparent to those skilled in the art that the PAC information may be represented by more bits or other methods. The TDSS may include areas assigned to flag and perform a control function together with the PAC information. The flag will be described in detail later.

As described above, the recording medium according to the present invention includes an area having recorded therein information for controlling access to the recording medium. One piece or plural pieces of access control information may be recorded if necessary. Hereinafter, an embodiment of the access control information recorded on the recording medium will be described in detail. In particular, for example, a case of including information for controlling access for reading when the recording/reproducing apparatus is desired to read specific data recorded on the recording medium or data recorded in a specific area will be described.

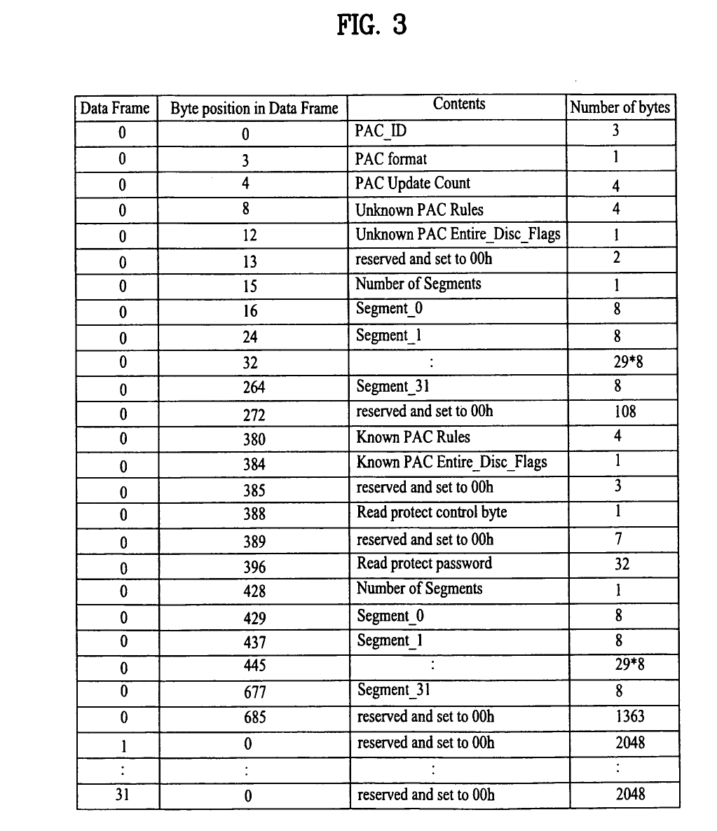

An example of the reading control information according to the present invention is shown in FIG. 3. In the present specification, for convenience of description, the reading control information is also referred to as a disc read protect PAC (hereinafter, referred to as “DRP_PAC”) information. The DRP_PAC information includes 32 sectors (also referred to as “data frames”), which configure one cluster and are recorded on the recording medium. Now, fields of the DRP_PAC information shown in FIG. 3 will be described in detail.

A “PAC_ID” field has three bytes and indicates the type of the PAC information. In the present embodiment, the PAC_ID may be defined to “44 52 50h”. In this case, when the “PAC_ID” field recorded on the loaded recording medium is “44 54 50h”, it is indicated that the DRP_PAC according to the present embodiment is recorded.

A “PAC format” field has one byte and indicates the version of the recorded “DRP_PAC” information.

A “PAC Update Count” field has four bytes, initially has “00 00 00 00h”, and increases one by one when the DRP_PAC information is upgraded.

An “Unknown PAC Rules” field has four bytes. The “Unknown PAC Rules” may be applied when the recording/reproducing apparatus does not recognize the loaded recording medium or the information recorded on the recording medium. For example, the “Unknown PAC Rules” field may be applied when the PAC information cannot be recognized. In particular, it is determined whether the PAC_ID read from the loaded recording medium is the known ID by comparing the PAC_ID read from the loaded recording medium with the PAC_ID which is previously stored in the recording/reproducing apparatus. When it is not determined to the known ID, the “Unknown PAC Rules” may be applied. That is, by providing the Unknown PAC Rules, the recording/reproducing apparatus which cannot recognize the PAC information of the loaded recording medium can allow only access to a restricted area of the recording medium.

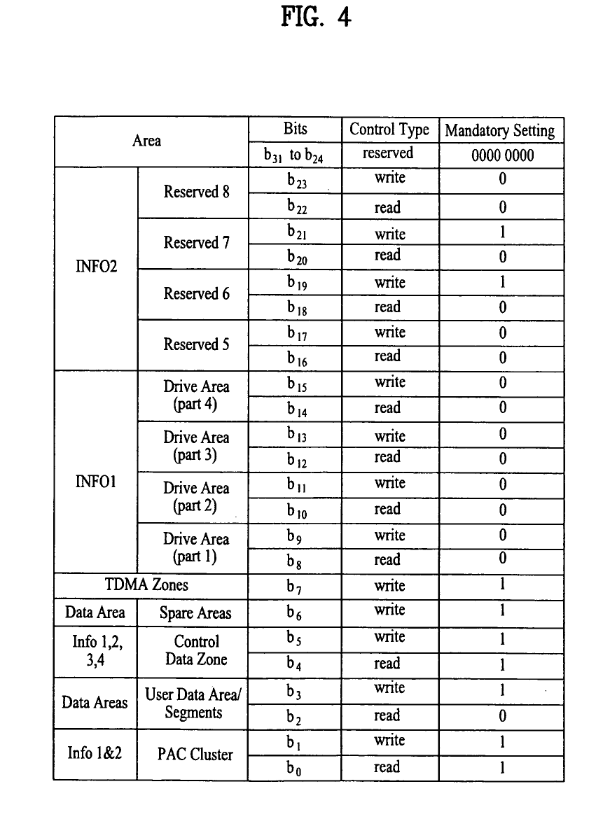

An example of the Unknown PAC Rules will be described with reference to FIG. 4. FIG. 4 is a view showing an example of the Unknown PAC Rules having four bytes, that is, 32 bits. Each bit defines whether reading or writing is possible in each area of the recording layer of the recording medium shown in FIG. 2. In the recording medium having a single recording layer, it is indicated whether the reading or the writing is possible in each area of the recording layer. Now, the respective fields will be described in detail.

An “Area” field indicates areas of the recording medium which can be controlled by the Unknown PAC Rules. That is, the “Area” field indicates the respective areas included in the INFO2 area, the INFO1 area, the TDMA and the data area shown in FIG. 2.

A “Bits” field is assigned to each area so as to indicate whether a function of each area is restricted. Since the “Unknown PAC Rules” field has four bytes, 32 bits are assigned to the respective areas.

A “Control Type” field indicates a function to which access will be controlled by the Unknown PAC Rules. In the present embodiment, it is defined whether data can be written or the recorded data can be read with respect to each area. In particular, in the present specification, for example, since the DRP_PAC information will be described, restriction on a reading operation will be described.

A “Mandatory Setting” field indicates binary values assigned to the respective bits. That is, the “Mandatory Setting” field indicates whether the reading or writing or allowed in the each area. With respect to all the areas except for the PAC area, the mandatory setting “0” may indicate allowance and “1” may indicate non-allowance (This mandatory setting is only exemplary and may be reversed). The reading having “1” indicates that the recording/reproducing apparatus cannot read data recorded on a target area of a loaded recording medium or play back the recorded data on a screen. Meanwhile, the PAC area is separately defined. In the writing, “0” indicates that the rewriting of current PAC information or the change of status indication information of the PAC information recorded in the TDDS is allowed and “0” indicates that the rewriting of current PAC information or the change of status indication information of the PAC information recorded in the TDDS is not allowed. In the reading, “0” indicates that data recorded in a target area can be read or played back and “1” indicates that the data recorded in the target area cannot be read or played back. The mandatory setting defined in FIG. 4 is only exemplary and may be variously changed if necessary. Since reserved areas 6 and 7 of the INFO2 area and drive areas of the INFO1 area may correspond to necessary bits, it is preferable that the reserved areas 6 and 7 of the INFO2 area and the drive areas of the INFO1 area are not changed if possible.

In the Unknown PAC Rules, the reading of the user data area/segment of the data area may be set to “1”. Therefore, the reading of the data recorded in the user data area/segments is not allowed according to this Unknown PAC Rules.

The “segment” indicates a target area of the user data area to which access is restricted. A user who records user data and a user having other authorization can set a part or all of the area, in which data is recorded, to the segment to which access is restricted. At this time, address information of the segment is recorded in a “Segments I” field of FIG. 3 and the number of segments in which the address information is recorded is recorded in a “Number of Segments” field. The segment information may not be recorded. Even when the segment information is not recorded, access to all of the user data area of the recording medium can be controlled.

An “Unknown PAC Entire_Disc_Flags” field of FIG. 3 has one byte and is the Unknown PAC Rules applied to the entire recording medium. For example, a function which has significant influence on the recording medium or the data recorded on the recording medium, such as re-initialization, may be controlled by an additional rule.

A “Known PAC Rules” field has four bytes. The Known PAC Rules are applied when the recording/reproducing apparatus can recognize the loaded recording medium or the information recorded on the recording medium. For example, the Known PAC Rules may be applied when the PAC information according to the present embodiment is recognized. In particular, when the PAC_ID information read from the loaded recording medium is identical to the PAC_ID information which is previously stored in the recording/reproducing apparatus, the Known PAC Rules may be applied.

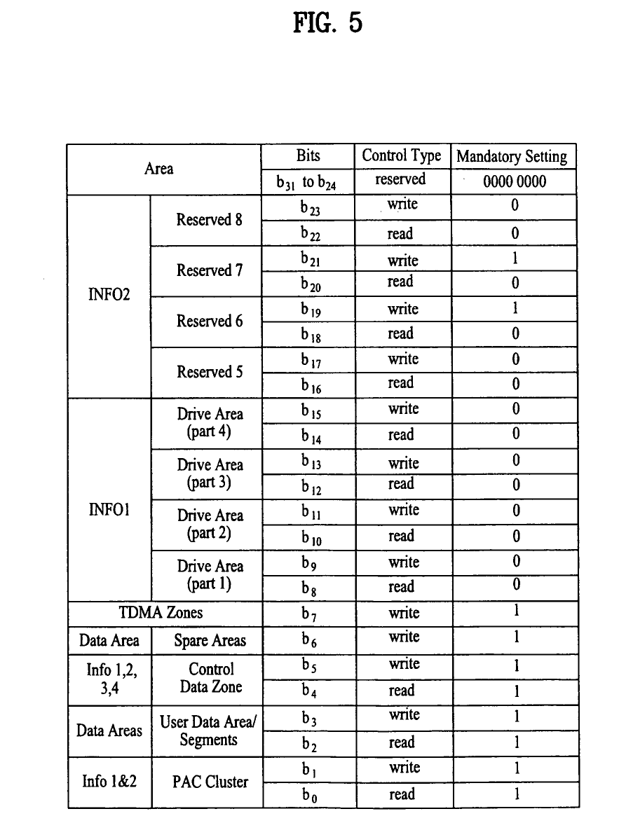

FIG. 5 is a view showing an example of the Known PAC Rules. The Known PAC Rules having four bytes, that is, 32 bits, will be described in detail with reference to FIG. 5. Similar to the Unknown PAC Rules shown in FIG. 4, it is defined whether the reading or writing is possible with respect to the recording layer of the recording medium. Since the detailed configuration and contents are equal to those of the Unknown PAC Rules, the description on the same parts will be omitted and a difference therebetween will be described.

In the Known PAC Rules, the reading of the data area is set to “0”. That is, the data reading which was restricted by the Unknown PAC Rules may be allowed by the Known PAC Rules. Therefore, different restriction rules may be applied depending on whether the recording/reproducing apparatus can recognize the loaded recording medium.

In the Known PAC Rules, segments may be separately defined. Therefore, a “Segments i” field and a “Number of Segments” field are separately included. That is, the data area different from that of the Unknown PAC Rules may be assigned to the segment. Therefore, the Known PAC Rules or the Unknown PAC Rules may be applied to different areas according to the requirement of the user.

The detailed contents are described in the Unknown PAC Rules and thus will be omitted. The segments to which the Known PAC Rules are applied are not separately defined as described below and the segments defined in the Unknown PAC Rules may be used. In this case, the separate segments need not to be defined and thus the fields may not be assigned.

A “Known PAC Entire_Disc_Flags” field of FIG. 3 has one byte and is the Known PAC Rules applied to the entire recording medium. For example, a function which has significant influence on the recording medium or the data recorded on the recording medium, such as re-initialization, may be controlled by an additional rule.

A “Read Protect Control byte” field (hereinafter, referred to as a “RPC field”) has one byte and applied according to the Known PAC Rules. For example, even when the recording/reproducing apparatus can recognize the recording medium and the Known PAC Rules are applied, an unauthorized person needs to be prevented from using the recording medium. Therefore, it is defined whether access of the unauthorized person is restricted using a password or whether segments to which access is restricted are separately defined.

Before the rule of the RPC field is described in detail, it needs to be defined whether access restriction is applied in a case of applying the Known PAC Rules. In the present embodiment, as described above, the flag is provided in the TDDS and will be described in detail as follows.

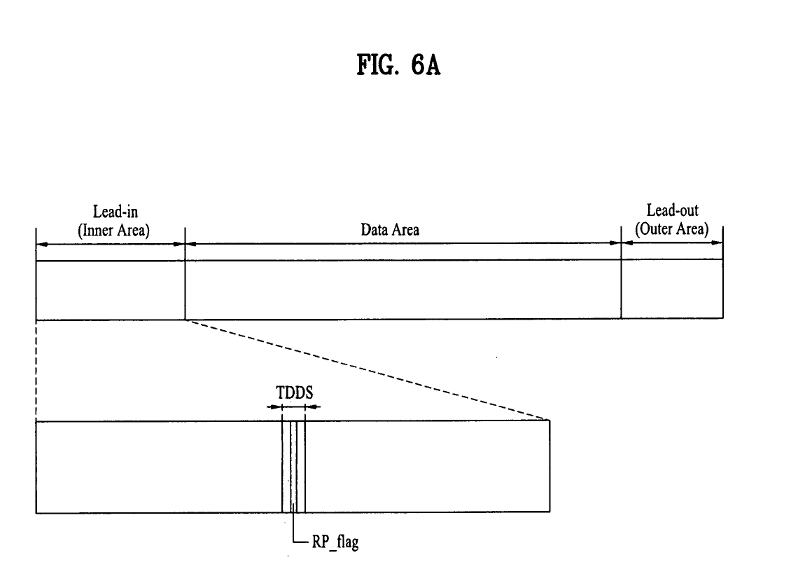

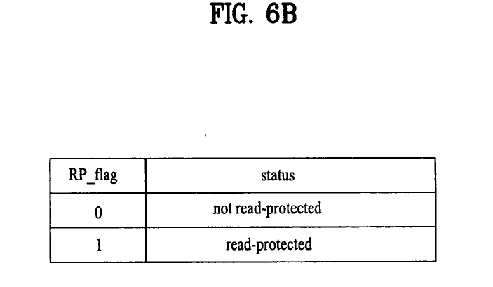

A “Read Protection flag” field (hereinafter, referred to as “RP_flag”) is provided in the TDDS shown in FIG. 6A. The RP_flag indicates the read protection status of the recording medium and may be applied to all the data areas except for the TDMA. The RP_flag may indicate whether the access is restricted in the case of applying the Known PAC Rules. For example, as shown in FIG. 6B, if the RP_flag is “0”, access restriction is in an “off” status and thus the reading is not restricted. That is, in the recording medium having reading control information according to the present embodiment, the reading is not controlled and thus the status corresponds to “not read-protected”. If the RG-flag is “1”, the access restriction is in an “on” status. Therefore, when the RP_flag is set to “1”, the definition of the RPC field may be applied. That is, in the recording medium having the reading control information according to the present embodiment, the reading is controlled and thus the status corresponds to “read-protected”.

Hereinafter, the definition of the RPC field will be described in detail. Since the RPC field has one byte, that is, 8 bits, desired control information may be assigned to the respective bits. For example, a segment selection bit may be assigned to a bit 3, a password setting bit may be assigned to a bit 2, and a protection method setting bit may be assigned to a bit 1. In this case, remaining bits may be reserved and may be assigned with other functions. The assignment of the bit is only exemplary and the present invention is not limited to the order thereof.

The segment selection bit may select segments to which the Known PAC Rules are applied by the selection of the user, when the Known PAC Rules are applied (the segment selection bit may be applied to the Unknown PAC Rules if necessary). For example, when the segment selection bit is set to “1”, the segment information defined in the Known PAC Rules is used, and, when the segment selection bit is set to “0”, the segment information defined in the Unknown PAC Rules is used.

The password setting bit determines whether the password is used or not. For example, when the password setting bit is set to “0”, the reading is possible without the password and, when the password setting bit is set to “1”, the playing-back is prevented and thus the password needs to be input. That is, when a password input by a user or a host is identical to the password which is previously stored in the recording medium, the reading or playing-back of the data is possible. When the password is set, the restriction is applied. Accordingly, the RP_flag of the TDDS is preferably set to “1”.

The password is assigned to the 32-bit “Read Protect Password” field of FIG. 3 such that 32 characters may be given to the password. If the password is not set in the password setting bit, this field is preferably set to “0”.

A method setting bit defines a reading protection method. For example, when the method setting bit is set to “0”, the protection method is a virtual method and, when the method setting bit is set to “1”, the protection method is a physical method. The virtual method and the physical method are determined depending on whether the flag provided in the TDDS will be changed or not.

The other fields are reserved and, if necessary, the reserved fields are assigned as necessary areas such that other functions may be added.

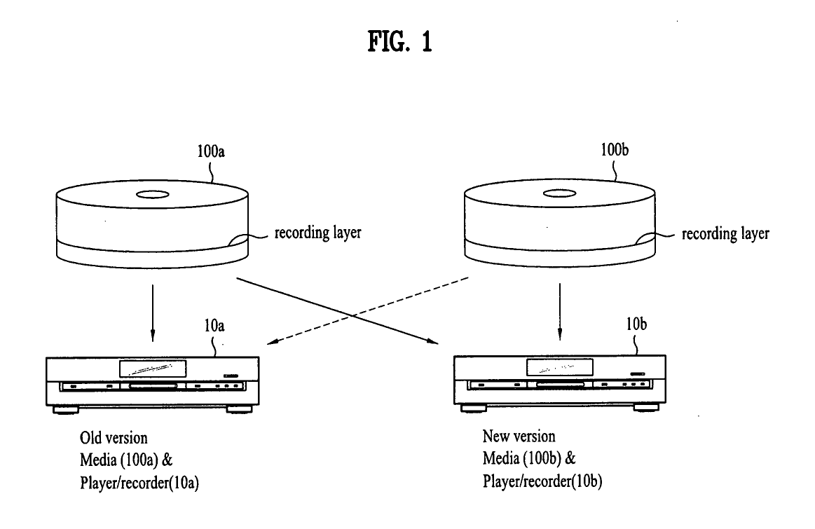

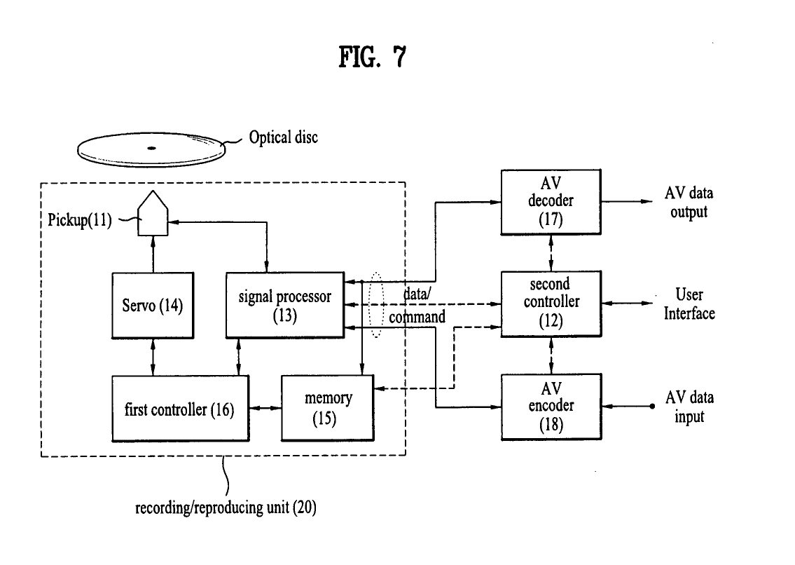

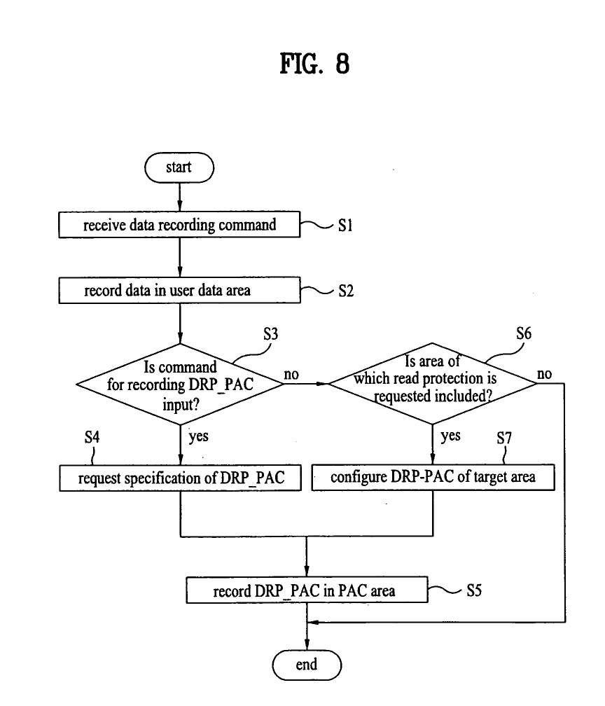

The recording/reproducing apparatus according to the embodiment of the present invention is shown in FIG. 7. The recording/reproducing apparatus according to the present invention includes a recording/reproducing unit 20 for recording/reproducing data on/from an optical disc, a controller 12 for controlling the recording/reproducing unit 20, an AV decoder 17 and an AV encoder 18. The recording/reproducing apparatus shown in FIG. 7 may be the recording/reproducing apparatus 10a or 10b shown in FIG. 1.

The recording/reproducing unit 20 includes a pickup unit 11 for directly recording/reading data on/from the optical disc, a signal processor 13 for receiving a signal read from the pickup unit 11, restoring the received signal to a desired signal value, or modulating a signal to be recorded into another signal recorded in the optical disc such that it transmits the recovered or modulated result, a servo unit 14 for controlling the pickup unit 11 so as to accurately read a signal from the optical disc and accurately record a signal on the optical disc, a memory 15 for temporarily storing control information or management information and data, and a first controller 16 for controlling the above-mentioned components. The recording/reproducing apparatus including only the recording/reproducing unit 20 is also referred to as a “driver” and is used as a peripheral device of a computer.

The second controller 12 controls all the components. In particular, in the present embodiment, the second controller 12 receives a user command through a user interface and transmits a recording/reproducing command for recording/reproducing data on/from the recording medium to the recording/reproducing unit 20.

The decoder 17 decodes and restores the signal read from the recording medium to desired information and provides the desired information to the user, according to the control of the second controller 12. The encoder 18 converts an input signal into a signal having a specific format, e.g., MPEG2 transport stream and provides the signal to the signal processor 13, according to the control of the second controller 12, in order to perform a function for recording a signal on the recording medium.

Hereinafter, a method for recording the DRP_PAC information on the recording medium using the recording/reproducing apparatus will be described in detail.

According to the embodiment of the present invention, the DRP_PAC may be recorded using the recording/reproducing apparatus such that data which is recorded on the recording medium by the user is not damaged or reproduced, duplicated or distributed by the unauthorized person. That is, when the user reproduces the data recorded on the recording medium using an old version of recording/reproducing apparatus such that the recording medium may be damaged or when copyright infringement such as unauthorized duplication or distribution of creative data may occur, the DRP_PAC may be recorded on the recording medium. Now, the method for recording the DRP_PAC information using the recording/reproducing apparatus will be described.

The recording/reproducing apparatus receives a data recording command (S1) and records the data on the user data area of the recording medium (S2). In order to restrict access for reading the data, if necessary, the user or the host inputs a command for recording the DRP_PAC information (S3). The second controller 12 of the recording/reproducing apparatus receives and encodes the command in the AV encoder 18 and transmits the encoded signal to the recording/reproducing unit 20. At this time, the recording/reproducing apparatus requests the user or the host to specify the DRP_PAC information (S4). That is, the recording/reproducing apparatus requests the segment information of areas in which the data reading is restricted and information on whether the data reading of the respective areas is restricted. Accordingly, the Known PAC Rules or the Unknown PAC Rules are applied to the specified areas. At this time, the area to which the Unknown PAC Rules are applied and the area to which the Known PAC Rules are applied may be different from each other. The recording/reproducing unit 20 receives address information of the DRP_PAC information to be recorded and data to be recorded. The first controller 16 of the recording/reproducing unit 20 transmits the received data to the servo unit 14 and the signal processor 13. The DRP_PAC information is recorded on a desired address of the recording medium through pickup unit 11 by the operations of the servo unit 14 and the signal processor 13 (S5).

When the user does not input the command for recording the DRP_PAC information, the first controller 16 of the recording/reproducing unit 20 or the second controller 12 of the recording/reproducing apparatus may determine whether an area of which read protection is requested is included (S6). For example, when it is determined that the data recorded on the entire recording medium or a specific area is hard to be recognized by the old version of recording/reproducing apparatus, the DRP_PAC information may be recorded without the command of the user. That is, it is determined whether an area of which the read protection is requested is included in the recording medium on which the data is recorded. The DRP_PAC information for the area of which the read protection is requested is configured (S7). The servo unit 14 and the signal processor 13 operate according to the command for recording the DRP_PAC information of the first controller 16 and the second controller 12 so as to record the configured DRP_PAC information in a desired address of the recording medium, that is, the PAC area, through the pickup unit 11 (S5).

At this time, the DRP_PAC information may be recorded in the PAC1 area of the 32 clusters assigned to the INFO1 area of FIG. 2 in the unit of one cluster. That is, the DRP_PAC information is recorded in the writable cluster according to status information of the PAC cluster indicated in the TDDS. If a defective PAC cluster is found in the recording process, the defective cluster is skipped, an invalid cluster is indicated in the TDDS (for example, status indication information is set to 10) and the information is recorded in a next valid cluster. When the PAC information is updated, a new version of PAC information is recorded in the next valid cluster and the status indication information of the cluster in which the old version of PAC information was recorded may indicate the invalid status (for example, the status indication information is set to 10). The PAC information recorded in the PAC1 area is copied and stored to and in the PAC2 area of 32 clusters assigned to the INFO2 area.

Since plural pieces of PAC information can be recorded on one recording medium, the DRP_PAC information according to the present embodiment may be recorded together with the PAC information for defining other rules. In this case, the rules are selectively applied and the function restricted by one piece of PAC information is preferably restricted regardless of the defined contents of the other PAC information.

At this time, the recorded DRP_PAC information prevents the access for reading recorded on the recording medium and the present invention is not limited to the above-described embodiment. However, for convenience of description, for example, the embodiment of FIG. 2 will be described.

The user or the recording/reproducing apparatus sets areas in which the data reading is restricted, that is, segments, and records address information of the segments in the “Segments i” field. The number of recorded segments is recorded in the “Number of Segments” field. As shown in FIG. 3, since the segments to which the Unknown PAC Rules and the Known PAC Rules are applied are defined, different segments may be specified if necessary. For example, segments in which data is apt to be damaged due to a difference in version may be set to the segments to which the Unknown PAC Rules are applied and segments which are desired to be protected from the copyright infringement may be set to the segments to which the Known PAC Rules are applied. It is preferable that the number of segments is at most 32. In the user data area, when the user or the recording/reproducing apparatus specifies the segments, the rules may be applied to the specified segments and, when the user or the recording/reproducing apparatus does not specify the segments, the rules may be applied to the entire recording medium.

In the Unknown PAC Rules and the Known PAC Rules, control information on whether access is possible is set, which will be described with reference to FIGS. 2 to 4. The reading control information for restricting the access to the recording medium may be provided and the DRP_PAC information according to the present embodiment may be selectively recorded if necessary.

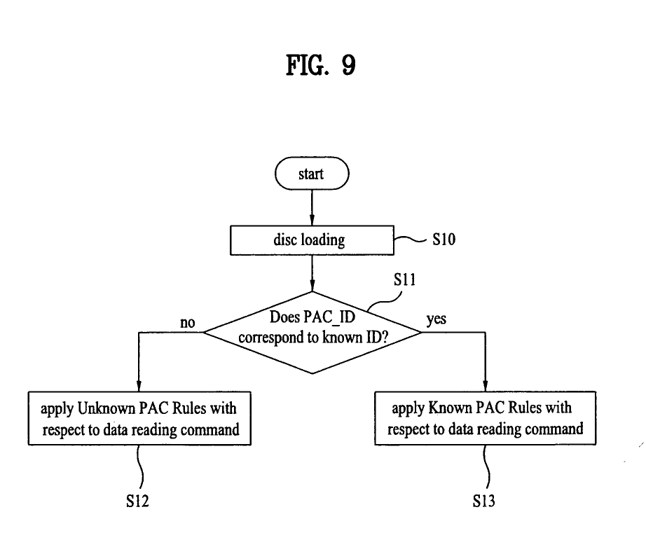

Hereinafter, when the DRP_PAC information is recorded, a method for reproducing the data from the recording medium will be described in detail with reference to FIG. 9.

When the recording medium is loaded into a recording/reproducing apparatus (S10), all management information of the recording medium is read and stored in the memory 15 of the recording/reproducing unit 20. The stored management information is used at the time of recording/reproducing the data on/from the recording medium.

First, the first controller 16 of the recording/reproducing unit 20 determines whether the PAC information included in the management information can be recognized (S11). For example, it is determined whether the PAC_ID information which is previously stored in the memory 15 is matched to the PAC_ID information read from the recording medium. When the matched PAC_ID information is not included, the PAC information corresponds to data recorded on the recording medium after manufacturing the recording/reproducing apparatus. That is, since the recording/reproducing apparatus may include an unknown function, the Unknown PAC Rules are applied (S12). In contrast, when the matched PAC_ID information is included, the recording/reproducing apparatus can recognize the type of the PAC information and thus the Known PAC Rules are applied (S13).

A case where the PAC_ID information can be recognized and a case where the PAC_ID information cannot be recognized will be described as follows. According to the Unknown PAC Rules, the reading of the data which is recorded in the segments specified by the recording/reproducing apparatus or the user is restricted. For example, the Unknown PAC Rules shown in FIG. 4 are applied such that the reading of the data recorded in the user data area or the specified segments is restricted and data recorded in the remaining areas can be read and played-back. Even when a recording medium including a function which cannot be recognized by the recording/reproducing apparatus is inserted and reproduced, a structure for reproducing data without an error is provided. In contrast, according to the Known PAC Rules, as shown in FIG. 5, the reading of the data recorded in the user data area or the segments may not be restricted. Alternatively, even in the Known PAC rules, the mandatory setting may be set to “0” such that the data recorded in the user data area or the segments is restricted. At this time, the area different from the segments of the Unknown PAC Rules may be set as the segments. Even in the Known PAC Rules, when a restricted area specified by the recording/reproducing apparatus or the user exists if necessary, the data except for the restricted area may be read.

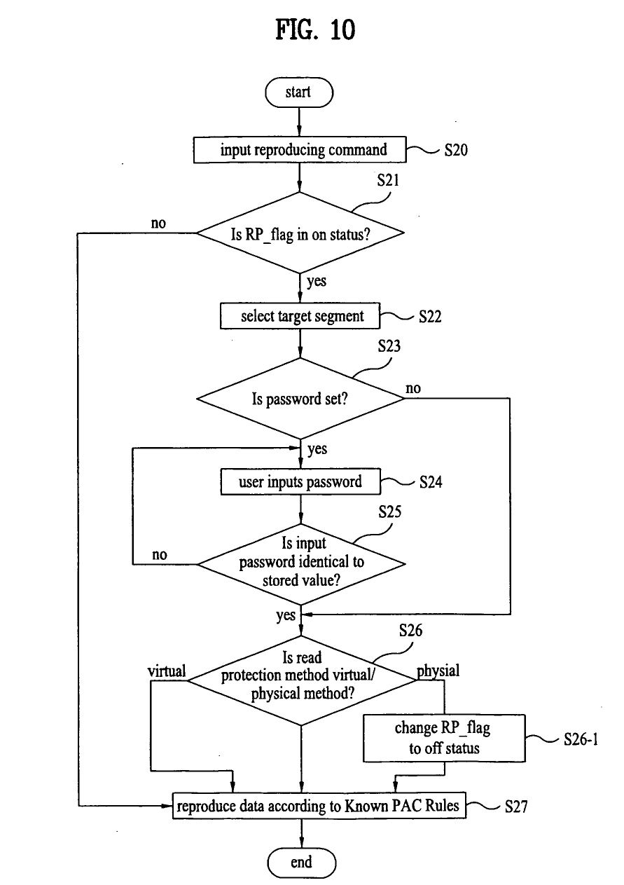

In the embodiment of the reproducing method according to the present invention, when the Known PAC Rules are applied, the process shown in FIG. 10 may be performed. The process is only exemplary and the present invention is not limited to the present embodiment.

When the user inputs a command for reproducing the data recorded on the recording medium (S20), the first controller 16 determines whether the RP-flag included in the TDDS is set to the “on” state. That is, as described above, when the RP-flag is set to “0”, the reading control status is the off status and thus the data is reproduced according to the Known PAC Rules of FIG. 5 (S27). In contrast, when the RP-flag is set to “1”, the reading control status is the on status and thus the data is reproduced according to the Known PAC Rules when a condition set to the RPC field is satisfied, which will be described on the basis of the above-described RPC.

The segment to which the Known PAC Rules are applied is selected through the segment selection bit, that is, the bit 3 of the RPC (S22). For example, when the bit 3 is “0”, the segment defined in the Unknown PAC Rules is used, and, when the bit 3 is “1”, the segment defined in the Known PAC Rules is used.

When the segment to which the Known PAC rules are applied is selected, it is determined whether a password is set in the bit 2 (S23). When the bit 2 is set to “1”, the user must input the password. The second controller 12 transmits the input password to the recording/reproducing unit 20 (S24). The first controller 16 of the recording/reproducing unit 20 determines whether the input password is identical to the password which is previously stored in the memory 15 (S25). When the password is not identical, the command of the user cannot be performed and thus the user is requested to input the password again. When the password is identical, the first controller 6 determines the read protection method (S26).

When the read protection method is the virtual method, the data is reproduced according to the Known PAC Rules (S27). That is, the bits set in the TDDS can be used without change. Therefore, since the “RP-flag is set to the on status even after the data is reproduced according to the command of the user, the data reading of the unauthorized person can be restricted.

Meanwhile, when the read protection method is the physical method, the RP-flag is changed to the off status (S26-1) and then the data is reproduced according to the Known PAC Rules (S27). Therefore, when the data reading of the unauthorized person is desired to be restricted by setting the password after reading the data using the physical method, the RP-flag must be changed to the on status and recorded.

According to the DRP-PAC information according to another embodiment of the present invention, the password may be used even when reading the user data area except for the segment in which the data reading is restricted according to the Unknown PAC Rules. That is, a field indicating whether a password is used and a password field may be assigned to a field to which the Unknown PAC Rules are applied. Alternatively, the password which is used when the Unknown PAC Rules are applied may be identical to the password defined in the Known PAC Rules. Accordingly, the reading can be restricted due to the difference in version according to the Unknown PAC Rules and the unauthorized person can be prevented from accessing to the data.

According to a recording medium and a method and apparatus for recording/reproducing data on/from the recording medium of the present invention, it is possible to compatibly reproduce the data from different versions of recording media.

According to the recording medium of the present invention, since a reading function is restricted, it is difficult for a user to access to the recording medium such that content protection can be improved.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

1. A recording medium comprising:
a data area in which data is recorded; and
a management area in which management information of the data is recorded,
wherein an area in which reading control information for controlling reading of the data is recorded is assigned to the management area.

2. The recording medium according to claim 1, wherein the reading control information is information for controlling the reading of all or a specific part of the data recorded on the recording medium.

3. The recording medium according to claim 2, wherein the management area includes a field having recorded therein address information of an area in which the data reading is controlled.

4. The recording medium according to claim 3, wherein the area in which the data reading is controlled is an area specified by a user in the data area recorded on the recording medium when recording the reading control information.

5. The recording medium according to claim 1, wherein the reading control information includes a first rule applied when the recording medium is recognized and a second rule applied when the recording medium is not recognized.

6. The recording medium according to claim 5, wherein it is determined whether the recording medium is recognized or not, on the basis of an identity (ID) included in the reading control information.

7. The recording medium according to claim 5, wherein the first rule or the second rule includes a request for input of the same password as a password stored previously.

8. The recording medium according to claim 7, wherein the password is set when recording the reading control information.

9. The recording medium according to claim 5, wherein the management area includes a field having recorded therein address information of a first area in which the data reading is controlled according to the first rule and a field having recorded therein address information of a second area in which the data reading is controlled according to the second rule.

10. The recording medium according to claim 9, wherein the management area further includes a field having recorded therein information for specifying a target area in the first area or the second area when the first rule or the second rule is applied.

11. The recording medium according to claim 5, wherein an area in which the data reading is controlled according to the first rule and an area in which the data reading is controlled according to the second rule are different from each other.

12. The recording medium according to claim 1, wherein the management area further includes status information of read protection information indicating an on/off status of the read protection information.

13. The recording medium according to claim 1, wherein the management area further includes a control information field for restricting initialization of the recording medium.

14. A method for reproducing data recorded on a recording medium, the method comprising:
obtaining reading control information recorded in a management area of the recording medium; and
controlling access for reading the data with respect to the data recorded on the recording medium or a predetermined area in which the data is recorded, according to the reading control information.

15. The method according to claim 14, wherein different rules for controlling the access for reading the data are applied depending on whether the recording medium is recognized or not.

16. The method according to claim 15, wherein the rules include a first rule which is applied when the recording medium is recognized and a second rule which is applied when the recording medium is not recognized.

17. The method according to claim 16, further comprising determining whether a user has a right of reading the data in the first rule or the second rule.

18. The method according to claim 17, wherein the determining of whether the user has the right of reading the data comprises requesting the same password as a password stored previously to be input.

19. The method according to claim 16, wherein the first rule is applied to first segment information for specifying a partial area of the recording medium and a second rule is applied to second segment information.

20. The method according to claim 16, further comprising selecting a target area from the first segment information and the second segment information of the recording medium when the first rule or the second rule is applied.

21. The method according to claim 15, wherein it is determined whether the recording medium is recognized or not, on the basis of an identity (ID) included in the reading control information.

22. The method according to claim 21, wherein it is determined that the recording medium is recognized, when the ID included in the reading control information is identical to any one of stored IDs.

23. The method according to claim 14, wherein access for reading a part or all of user data recorded on the recording medium is controlled.

24. The method according to claim 14, further comprising checking an on/off status of read protection information of the recording medium.

25. The method according to claim 24, further comprising checking whether the read protection information is changed to the off status after reading the data.

26. A method for recording data on a recording medium, the method comprising:
recording the data in a data area of the recording medium; and
recording management information of the data in a management area of the recording medium,
wherein the management information includes reading control information for controlling reading of the recorded data.

27. The method according to claim 26, wherein the reading control information controls the reading of all or a part of the data.

28. The method according to claim 26, wherein the data of which the reading is controlled or address information of an area in which the data is recorded are recorded together.

29. The method according to claim 26, wherein the reading control information includes a first rule which is applied when the recording medium is recognized and a second rule which is applied when the recording medium is not recognized.

30. The method according to claim 29, wherein it is determined whether the recording medium is recognized or not, on the basis of an identity (ID) included in the reading control information.

31. The method according to claim 29, wherein address information of a first area having recorded therein data to which the first rule is applied and address information of a second area having recorded therein data to which the second rule is applied are recorded together.

32. The method according to claim 31, wherein the first area and the second area are different from each other.

33. The method according to claim 26, wherein the reading control information includes a field indicating whether a password is set or not.

34. The method according to claim 26, further comprising recording status information indicating an on/off status of the reading control information.

35. An apparatus for recording/reproducing data on/from a recording medium, the apparatus comprising:
a pickup unit; and
a controller which controls access for reading the data with respect to the data recorded on the recording medium or a predetermined area in which the data is recorded, according to reading control information recorded in a management area of the recording medium.

36. The apparatus according to claim 36, wherein the controller applies different rules for controlling the access for reading the data, depending on whether the recording medium is recognized or not.

37. The apparatus according to claim 36, wherein the rules include a first rule which is applied when the recording medium is recognized and a second rule which is applied when the recording medium is not recognized.

38. The apparatus according to claim 37, wherein the controller determines whether a user has a right of reading the data and applies the first rule or the second rule.

39. The apparatus according to claim 38, wherein the controller compares a password input by the user with a password stored previously so as to determine whether the user has the right of reading the data.

40. The apparatus according to claim 37, wherein the controller compares an identity (ID) included in the reading control information with stored IDs so as to determine whether the recording medium is recognized or not.
